(19) United States
(12) Patent Application Publication
(10) Pub. No.: US 2025/0299296 A1
(43) Pub. Date: Sep. 25, 2025

(54) ELECTRONIC DEVICE FOR UPSCALING IMAGE AND CONTROLLING METHOD THEREOF

(71) Applicant: SAMSUNG ELECTRONICS CO., LTD., Suwon-si (KR)

(72) Inventors: Jisu LEE, Suwon-si (KR); Cheon LEE, Suwon-si (KR)

(73) Assignee: SAMSUNG ELECTRONICS CO., LTD., Suwon-si (KR)

(21) Appl. No.: 19/228,065

(22) Filed: Jun. 4, 2025

Related U.S. Application Data
(63) Continuation of application No. PCT/KR2023/018792, filed on Nov. 21, 2023.

(30) Foreign Application Priority Data
Jan. 4, 2023 (KR) 10-2023-0001072

(51) Int. Cl. G06T 3/4046

(52) U.S. Cl. CPC G06T 3/4046

(57) ABSTRACT

Provided is an electronic device and method of operating same, the electronic device including: memory storing instructions; and a processor configured to execute the instructions to: obtain an upscaled image by upscaling a plurality of pixels of an image; obtain channel groups by unshuffling pixels of the upscaled image; update the channel groups by subtracting a value based on a position of a pixel included in each of the channel groups in the upscaled image from a pixel value included in each of the channel groups; generate high-resolution channel groups by inputting the updated channel groups to a neural network; obtain a processed image having a resolution that is the same as a resolution of the upscaled image by shuffling the high-resolution channel groups; and obtain a final image in which the image is upscaled by performing convolution on the processed image with a preset filter.

### CROSS-REFERENCE TO RELATED APPLICATIONS

This application is a by-pass continuation of International Application No. PCT/KR2023/018792, filed on Nov. 21, 2023, which is based on and claims priority to Korean Patent Application No. 10-2023-0001072, filed in the Korean Intellectual Property Office on Jan. 4, 2023, the disclosures of which are incorporated by reference herein in their entireties.

### BACKGROUND

### 1. Field

The present disclosure relates to an electronic device and a controlling method thereof, and more particularly to, an electronic device for upscaling an image and a controlling method thereof.

### 2. Description of Related Art

With the development of electronic technology, various types of electronic devices are being developed. In particular, the recent proliferation of devices with large screens has led to the development of methods for handling high-resolution content.

In particular, recently, various learning-based image processing algorithms using neural networks have been developed. Through deep learning-based image processing network learning methods using learning data in the form of combined input and output, various problems that could not be solved using traditional methods are now being solved.

For example, image high-resolution technique using a neural network is technology that learns the difference between a low-resolution image and a high-resolution image, and restores sharper and more detailed signals when a low-resolution image is converted into a high-resolution image. A general high-resolution technique goes through a step of downgrading an original high resolution (HR) image to a low resolution (LR) image and then restoring it to a super resolution (SR) image. It is important to design a technique and network that restores information lost while downgrading HR images to LR images as much as possible.

### SUMMARY

Provided is an electronic device that performs appropriate preprocessing to increase upscaling performance through a neural network model and a controlling method thereof.

According to an aspect of the disclosure, an electronic device includes: memory storing one or more instructions; and at least one processor configured to individually or collectively execute the one or more instructions, wherein the one or more instructions, when individually or collectively executed by the at least one processor, cause the electronic device to: obtain an upscaled image by upscaling each of a plurality of pixels of an image; obtain a plurality of channel groups by unshuffling a plurality of pixels of the upscaled image; update the plurality of channel groups by subtracting a value based on a position of a pixel included in each of the plurality of channel groups in the upscaled image from a pixel value included in each of the plurality of channel groups; generate a high-resolution plurality of channel groups by inputting the updated plurality of channel groups to a neural network model stored in the memory; obtain a processed image having a resolution that is the same as a resolution of the upscaled image by shuffling the high-resolution plurality of channel groups; and obtain a final image in which the image is upscaled by performing convolution on the processed image with a preset filter.

The one or more instructions, when individually or collectively executed by the at least one processor, may further cause the electronic device to: obtain a first channel group among the plurality of channel groups as a channel group corresponding to the image; and update the plurality of channel groups by subtracting a pixel value of the first channel group corresponding to a pixel included in each of a plurality of second channel groups from a pixel value included in each of the plurality of second channel groups, wherein the plurality of second channel groups is included in the plurality of channel groups.

The upscaled image may include a plurality of sub images, and the one or more instructions, when individually or collectively executed by the at least one processor, may further cause the electronic device to: obtain the upscaled image by upscaling each of a plurality of pixels included in the image; and update the plurality of channel groups by subtracting a preset pixel value closest to a position of a pixel included in each of a first subset of channel groups among the plurality of channel groups, among a plurality of preset pixels included in the plurality of sub images, from a pixel value included in each of the first subset of channel groups.

The one or more instructions, when individually or collectively executed by the at least one processor, may further cause the electronic device to obtain, based on the plurality of pixels, a second subset of channel groups including remaining channel groups, among the plurality of channel groups, excluding the first subset of channel groups.

The one or more instructions, when individually or collectively executed by the at least one processor, may further cause the electronic device to collectively identify a pixel at a vertex in each of the plurality of sub images as the plurality of preset pixels.

The one or more instructions, when individually or collectively executed by the at least one processor, may further cause the electronic device to update the plurality of channel groups by subtracting an average value of a plurality of pixels included in the upscaled image from a pixel value included in each of the plurality of channel groups.

The one or more instructions, when individually or collectively executed by the at least one processor, may further cause the electronic device to: obtain a first channel group among the plurality of channel groups as a channel group corresponding to the image; and update the plurality of channel groups by subtracting one of an average value and a median value of a plurality of pixels included in the first channel group from a pixel value included in each of a plurality of second groups, wherein the plurality of second groups includes all channel groups of the plurality of channel groups excluding the first channel group.

The one or more instructions, when individually or collectively executed by the at least one processor, may further cause the electronic device to, based on the subtracted value exceeding a preset first value, update the plurality of channel groups by clamping the subtracted value to the preset first value, and the preset first value may be a maximum pixel value.

The one or more instructions, when individually or collectively executed by the at least one processor, may further cause the electronic device to obtain the subtracted value by subtracting the preset first value and a preset second value from a pixel value included in each of the plurality of channel groups, and the preset second value may be a middle value between a minimum pixel value and the maximum pixel value.

The one or more instructions, when individually or collectively executed by the at least one processor, may further cause the electronic device to: cause the high-resolution plurality of channel groups to have 1:1 high-resolution by inputting the updated plurality of channel groups to the neural network model; and obtain the processed image having the same resolution as the upscaled image by shuffling the plurality of 1:1 high-resolution channel groups.

According to an aspect of the disclosure, a method of controlling an electronic device includes: obtaining an upscaled image by upscaling each of a plurality of pixels of an image; obtaining a plurality of channel groups by unshuffling a plurality of pixels of the upscaled image; updating the plurality of channel groups by subtracting a value based on a position of a pixel included in each of the plurality of channel groups in the upscaled image from a pixel value included in each of the plurality of channel groups; generating a high-resolution plurality of channel groups by inputting the updated plurality of channel groups to a neural network model stored in a memory of the electronic device; obtaining a processed image having a resolution that is the same as a resolution of the upscaled image by shuffling the high-resolution plurality of channel groups; and obtaining a final image in which the image is upscaled by performing convolution on the processed image with a preset filter.

The obtaining the plurality of channel groups may further include obtaining a first channel group among the plurality of channel groups as a channel group corresponding to the image, and the updating the plurality of channel groups may further include subtracting a pixel value of the first channel group corresponding to a pixel included in each of a plurality of second channel groups from a pixel value included in each of the plurality of second channel groups, wherein the plurality of second channel groups is included in the plurality of channel groups.

The upscaled image may include a plurality of sub images, the obtaining the upscaled image may further include upscaling each of a plurality of pixels included in the image to obtain the upscaled image; and the updating the plurality of channel groups may further include subtracting a preset pixel value closest to a position of a pixel included in each of a first subset of channel groups among the plurality of channel groups, among a plurality of preset pixels included in the plurality of sub images, from a pixel value included in each of the first subset of channel groups.

The obtaining the plurality of channel groups may further include obtaining, based on the plurality of preset pixels, a second subset of channel groups including remaining channel groups, among the plurality of channel groups, excluding the first subset of channel groups.

The obtaining the plurality of channel groups may further include collectively identifying a pixel at a vertex in each of the plurality of sub images as the plurality of preset pixels.

### BRIEF DESCRIPTION OF THE DRAWINGS

The above and other aspects and features of certain embodiments of the present disclosure will be more apparent from the following description taken in conjunction with the accompanying drawings, in which:

FIGS. 1A, 1B, 1C, 1D, 1E, and 1F are views provided to explain an upscaling method to aid in understanding the present disclosure;

FIG. 2 is a block diagram illustrating a configuration of an electronic device according to one or more embodiments;

FIG. 3 is a block diagram illustrating a detailed configuration of an electronic device according to one or more embodiments;

FIGS. 4 and 5 are views provided to explain a preprocessing method according to one or more embodiments;

FIGS. 6, 7, and 8 are views provided to explain a preprocessing method according to one or more embodiments; and

FIG. 9 is a flowchart provided to explain a method of controlling an electronic device according to one or more embodiments.

### DETAILED DESCRIPTION

Hereinafter, the present disclosure is described in detail with reference to the accompanying drawings.

General terms that are currently widely used are selected as the terms used in the embodiments of the disclosure in consideration of their functions in the disclosure, but may be changed based on the intention of those skilled in the art or a judicial precedent, the emergence of a new technique, or the like. In addition, in a specific case, terms arbitrarily chosen by an applicant may exist, in which case, the meanings of such terms will be described in detail in the corresponding descriptions of the disclosure. Thus, the terms used in the embodiments of the disclosure need to be defined on the basis of the meanings of the terms and the overall contents throughout the disclosure rather than simple names of the terms.

In the disclosure, the expressions “have”, “may have”, “include” or “may include” used herein indicate existence of corresponding features (e.g., elements such as numeric values, functions, operations, or components), but do not exclude presence of additional features.

As used herein, the expressions “at least one of a, b or c” and “at least one of a, b and c” indicate “only a,” “only b,” “only c,” “both a and b,” “both a and c,” “both b and c,” and “all of a, b, and c.”

Expressions “first”, “second”, “1st,” “2nd,” or the like, used in the disclosure may indicate various components regardless of sequence and/or importance of the components, will be used only in order to distinguish one component from the other components, and do not limit the corresponding components.

Singular expressions include plural expressions unless the context clearly dictates otherwise. In this specification, terms such as “comprise” or “have” are intended to designate the presence of features, numbers, steps, operations, components, parts, or a combination thereof described in the specification, but are not intended to exclude in advance the possibility of the presence or addition of one or more of other features, numbers, steps, operations, components, parts, or a combination thereof.

In this specification, the term “user” may refer to a person using an electronic device or a device using an electronic device (e.g., an artificial intelligence electronic device).

Hereinafter, various embodiments of the present disclosure will be described in detail with reference to the accompanying drawings.

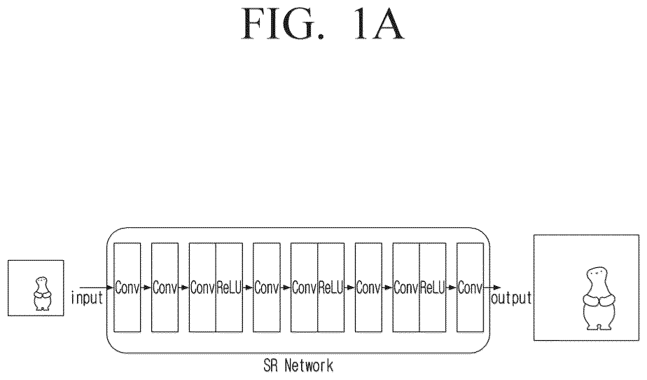

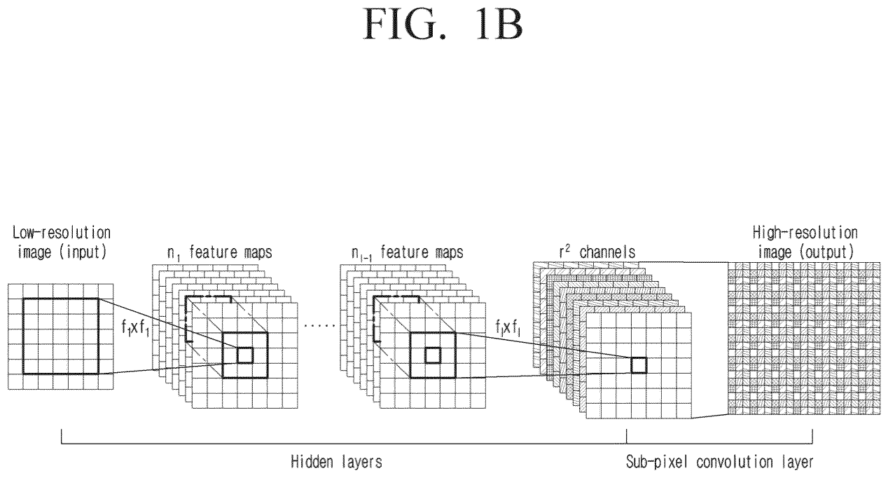

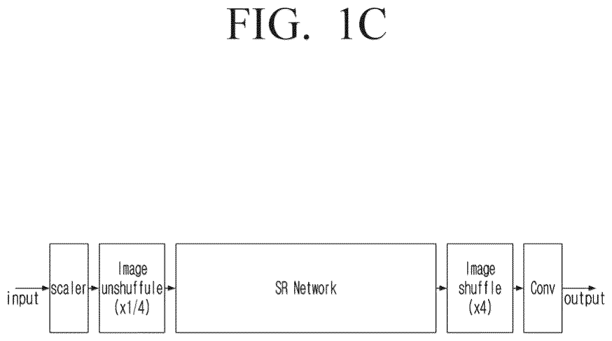

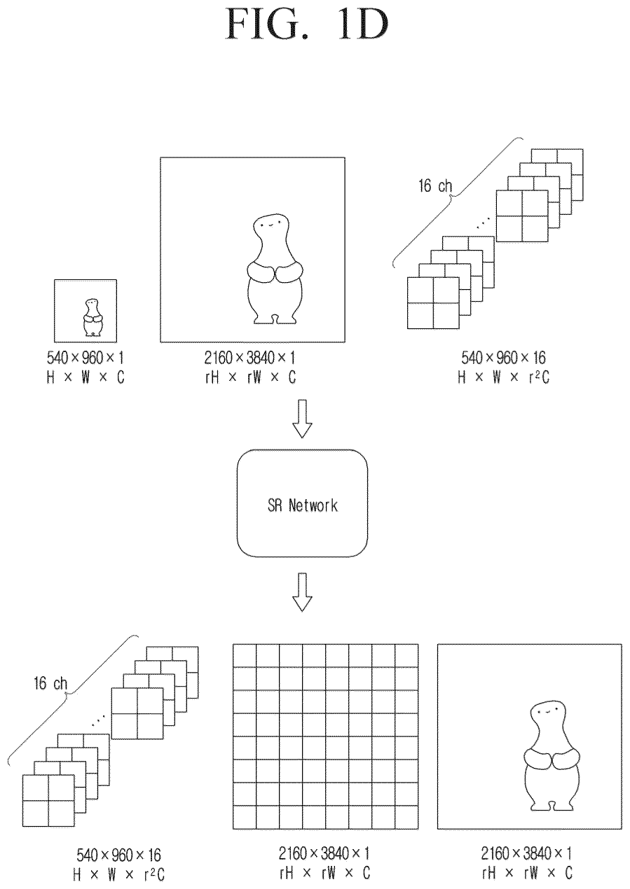

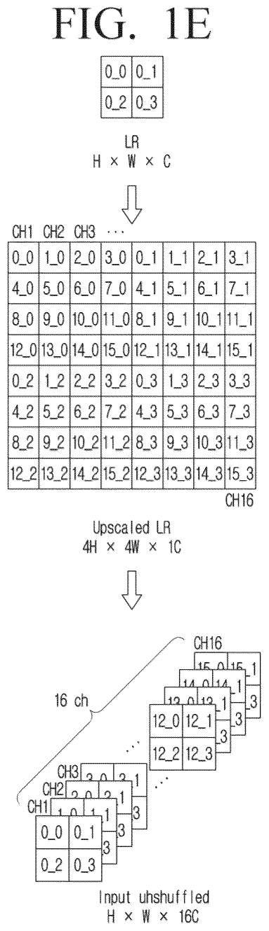

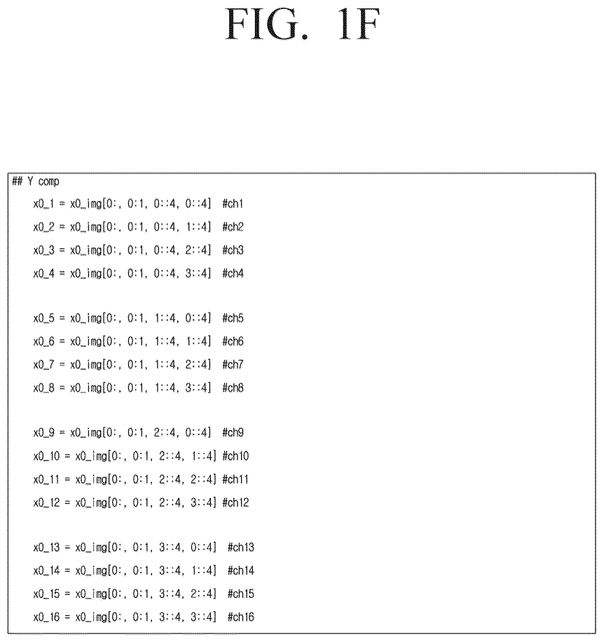

FIGS. 1A to 1F are views provided to explain an upscaling method to aid in understanding the present disclosure.

FIG. 1A is an example of a neural network model (also referred to herein as a “network”) that performs upscaling where the neural network model learns the difference between a low-resolution image and a high-resolution image. When a low-resolution image is input to a neural network model that has completed learning, a high-resolution image can be output. Through this process, the high-resolution image may be sharper and more detailed than the low-resolution image.

However, in the case of image processing devices such as TVs, since the resolution of an input image is not fixed, it is necessary to support various upscaling ratios that are suitable for the input in order to maintain a constant output resolution. In this case, performance can be improved by using an optimal model depending on the input resolution, but since the neural network-based algorithm requires a large amount of computation and the hardware is complex, it is necessary to design it to support all inputs in the same network to improve efficiency.

In one or more embodiments, a pixel shuffle method may be used, as shown in FIG. 1B. For example, when the original image was H×W in size, the image upscaled by r times becomes rH×rW in size, and in the efficient sub-pixel convolution layer, the number of channels, which is the last layer of FIG. 1B, the number of channels (number of feature maps) is increased by r\hat{ }2, and one pixel from each of the feature maps may be sequentially combined and reconstructed into a high-resolution image. As a result, one high-resolution image may be obtained from one original image.

This scheme can be used not only at the last stage but also at the input stage, as shown in FIG. 1D. For example, as shown in FIG. 1C, any original image of any resolution may be upscaled to 4K resolution, and the upscaled image may be changed to 16 channels through unshuffling, and then input to the network. Subsequently, the feature map output from the network may be shuffled to obtain a high-resolution image, and through this scheme, images of various resolutions may become high-resolution images via a single network.

FIG. 1D illustrates the upscaling operation, the unshuffling operation, the network operation, and the shuffle operation in greater detail. For a more specific explanation, referring to FIG. 1E, the original image of H×W×C may be upscaled to 4H×4W×1C. For example, based on four pixels of 0_0, 0_1, 0_2, and 0_3 included in the low-resolution image of FIG. 1E, 15 additional pixels may be created, respectively, to obtain the upscaled image of 0_0˜15_0, 0_1˜15_1, 0_2˜15_2, and 0_3˜15_3, which is 4 times the size in both width and height. Subsequently, the image of 4H×4W×1C may be unshuffled to obtain 16 channels. FIG. 1F illustrates an example of a method of unshuffling.

However, in such a preprocessing step, upscaling is performed using a traditional interpolation method and thus, the high-resolution effect may be reduced compared to a case in which a low-resolution image is input to a network without interpolation.

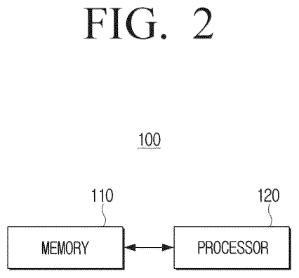

FIG. 2 is a block diagram illustrating configuration of an electronic device 100 according to one or more embodiments. The electronic device 100 includes memory 110 and a processor 120, as shown in FIG. 2.

The electronic device 100 is a device that upscales an image, and may be set-top box (STB), desktop PC, laptop, smartphone, tablet PC, server, television, or the like. However, the electronic device 100 is not limited thereto, and may be any device capable of upscaling an image.

The memory 110 may refer to hardware that stores information such as data in an electrical or magnetic form so that it can be accessed by the processor 120 or the like. To this end, the memory 110 may be implemented as at least one hardware among non-volatile memory, volatile memory, flash memory, hard disk drive (HDD) or sold state drive (SDD), RAM, ROM, etc.

The memory 110 may store at least one instruction or module required for the operations of the electronic device 100 or the processor 120. Here, the instruction is a code unit that instructs the operations of the electronic device 100 or the processor 120, and may be written in a machine language, which is a language that can be understood by a computer. The module may be a set of instructions that perform a specific task of a task unit.

The memory 110 may store data, which is information in bit or byte units capable of representing characters, numbers, images, etc. For example, the memory 110 may store a neural network model.

The memory 110 can be accessed by the processor 120, and reading/recording/modifying/deleting/updating instructions, modules or data can be performed by the processor 120.

The processor 120 controls the overall operations of the electronic device 100. Specifically, the processor 120 is connected to each component of the electronic device 100 to control the overall operations of the electronic device 100. For example, the processor 120 may be connected to the memory 110, a communication interface (not shown), a display (not shown), or the like to control the operations of the electronic device 100.

The at least one processor 120 may include one or more of a central processing unit (CPU), a graphics processing unit (GPU), an accelerated processing unit (APU), a many integrated core (MIC), a neural processing unit (NPU), a hardware accelerator, or a machine learning accelerator. The at least one processor 120 may control one or any combination of the other components of the electronic device 100, and may perform communication-related operations or data processing. The at least one processor 120 may individually or collectively execute one or more programs or instructions stored in the memory 110. For example, the at least one processor 120 may perform a method according to one or more embodiments by executing one or more instructions stored in the memory 110.

When a method according to one or more embodiments includes a plurality of operations, the plurality of operations may be performed by one processor or by a plurality of processors. For example, when a first operation, a second operation, and a third operation are performed by the method according to one or more embodiments, all of the first operation, the second operation, and the third operation may be performed by the first processor, or the first operation and the second operation may be performed by the first processor (e.g., a general-purpose processor) and the third operation may be performed by the second processor (e.g., an artificial intelligence-dedicated processor).

The at least one processor 120 may be implemented as a single core processor including a single core, or as one or more multicore processors including a plurality of cores (e.g., homogeneous multicore or heterogeneous multicore). When the at least one processor 120 is implemented as a multicore processor, each of the plurality of cores included in the multicore processor may include internal memory of the processor, such as cache memory and an on-chip memory, and a common cache shared by the plurality of cores may be included in the multicore processor. Each of the plurality of cores (or some of the plurality of cores) included in the multi-core processor may independently read and perform program instructions to implement the method according to one or more embodiments, or all (or some) of the plurality of cores may be coupled to read and perform program instructions to implement the method according to one or more embodiments.

When a method according to one or more embodiments includes a plurality of operations, the plurality of operations may be performed by one core of a plurality of cores included in a multi-core processor, or may be performed by a plurality of cores. For example, when a first operation, a second operation, and a third operation are performed by a method according to one or more embodiments, all of the first operation, the second operation, and the third operation may be performed by the first core included in the multi-core processor, or the first operation and the second operation may be performed by the first core included in the multi-core processor and the third operation may be performed by the second core included in the multi-core processor.

In one or more embodiments of the present disclosure, the at least one processor 120 may mean a system-on-chip (SoC) in which one or more processors and other electronic components are integrated, a single-core processor, a multi-core processor, or a core included in a single-core processor or multi-core processor and here, the core may be implemented as CPU, GPU, APU, MIC, NPU, hardware accelerator, or machine learning accelerator, and the like, but the core is not limited to the embodiments of the present disclosure. However, hereinafter, for convenience of explanation, the operations of the electronic device 100 will be described using the term “processor 120.”

The processor 120 may upscale each of a plurality of pixels included in an image to obtain an upscaled image. For example, the processor 120 may upscale an image of H×W×C to an image of 4H×4W×1C.

The processor 120 may unshuffle a plurality of pixels included in the updated image to obtain a plurality of channel groups, and may update the plurality of channel groups by subtracting a value determined based on a position of a pixel included in each of the plurality of channel groups in the upscaled image from a pixel value included in each of the plurality of channel groups.

For example, the processor 120 may unshuffle a plurality of pixels included in the upscaled image to 4H×4W×1C in order to obtain 16 channel groups, and update the 16 channel groups by subtracting a value determined based on a position of a pixel included in each of the 16 channel groups in the image that is upscaled to 4H×4W×1C from a pixel value included in each of the 16 channel groups.

For instance, the processor 120 may obtain a first group among a plurality of groups as a group corresponding to the image, and update the plurality of channel groups by subtracting a pixel value of the first group corresponding to a pixel included in each of the plurality of second groups from a pixel value included in each of a plurality of second groups, which are the remaining groups among the plurality of channel groups. In other words, the processor 120 may update the plurality of channel groups by subtracting a pixel of the original image from each pixel generated in the scaling process.

Alternatively, the processor 120 may upscale each of a plurality of pixels included in the image to obtain an upscaled image including a plurality of sub images, and update the plurality of channel groups by subtracting a preset pixel value closest to a position of a pixel included in each of some channel groups among a plurality of preset pixels included in the plurality of sub images from a pixel value included in each of some channel groups among the plurality of channel groups.

Here, the processor 120 may obtain remaining channel groups excluding some channel groups among the plurality of channel groups based on the plurality of preset pixels. For instance, the processor 120 may identify a pixel disposed at a vertex in each of the plurality of sub-images as the plurality of preset pixels. In other words, the processor 120 may obtain a first channel group, which is some of the plurality of channel groups, as the plurality of preset pixels, and update the plurality of channel groups by subtracting a corresponding pixel among pixels included in the first channel group from each pixel included in a second channel group, which is the remainder of the plurality of channel groups.

Alternatively, the processor 120 may update the plurality of channel groups by subtracting an average value of a plurality of pixels included in the upscaled image from a pixel value included in each of the plurality of channel groups. In this case, the same value may be subtracted from all the pixels included in the plurality of channel groups.

Alternatively, the processor 120 may update the plurality of channel groups by obtaining a first group among the plurality of channel groups as a group corresponding to the image and subtracting one of an average value and a median value of a plurality of pixels included in the first group from a pixel value included in each of the plurality of second groups, which are the remainder of the plurality of channel groups. In this case, different values for each channel group may be subtracted from the pixels included in the plurality of channel groups.

When the subtracted value exceeds a preset first value, the processor 120 may update the plurality of channel groups by clamping the subtracted value with the preset first value. Here, the preset first value may be a maximum pixel value.

The processor 120 may obtain the subtracted value by subtracting the preset value and a preset second value from the pixel value included in each of the plurality of channel groups. Here, the preset second value may be a middle value between the minimum pixel value and the maximum pixel value.

The processor 120 may input the updated plurality of channel groups into a neural network model to generate a high-resolution plurality of channel groups, shuffle the high-resolution plurality of channel groups to obtain a processed image having the same resolution as the upscaled image, and perform convolution on the obtained image with a preset filter to obtain a final image in which the image is upscaled.

For example, the processor 120 may input the updated plurality of channel groups into a neural network model to make the updated plurality of channel groups have 1:1 high-resolution, shuffle the plurality of 1:1 high-resolution channel groups to obtain an image having the same resolution as the upscaled image, and perform convolution on the obtained image with a preset filter to obtain a final image in which the image is upscaled.

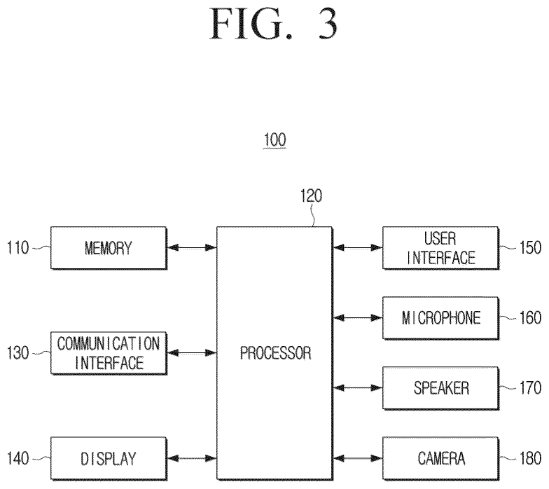

FIG. 3 is a block diagram illustrating detailed configuration of the electronic device 100 according to one or more embodiments.

FIG. 3 is a block diagram illustrating detailed configuration of the electronic device 100 according to one or more embodiments. The electronic device 100 may include memory 110 and a processor 120. Referring to FIG. 3, the electronic device 100 may further include a communication interface 130, a display 140, a user interface 150, a microphone 160, a speaker 170, and a camera 180. For the components illustrated in FIG. 3 that overlap with the components illustrated in FIG. 2, a detailed description will be omitted.

The communication interface 130 is configured to perform communication with various types of external devices according to various types of communication methods. For example, the electronic device 100 may perform communication with a server or a user terminal device via the communication interface 130.

The communication interface 130 may include a Wi-Fi module, a Bluetooth module, an infrared communication module, a wireless communication module, and the like. Here, each communication module may be implemented in the form of at least one hardware chip.

The Wi-Fi module and the Bluetooth module perform communication using a Wi-Fi method and a Bluetooth method, respectively. When using a Wi-Fi module or a Bluetooth module, various connection information such as SSID and session keys are first transmitted and received, and various information can be transmitted and received after establishing communication connection using this. The infrared communication module performs communication according to an infrared Data Association (IrDA) communication technology which transmits data wirelessly over a short distance using infrared rays between optical light and millimeter waves.

The wireless communication module includes at least one communication chip that performs communication according to various wireless communication standards, such as Zigbee, 3rd Generation (3G), 3rd Generation Partnership Project (3GPP), Long Term Evolution (LTE), LTE advanced (LTE-A), 4th Generation (4G), 5th Generation (5G), etc. in addition to the above-described communication methods.

Alternatively, the communication interface 130 may include a wired communication interface such as HDMI, DP, Thunderbolt, USB, RGB, D-SUB, DVI, etc.

In addition, the communication interface 130 may include at least one of a Local Area Network (LAN) module, an Ethernet module or a wired communication module that performs communication using a pair cable, a coaxial cable or an optical fiber cable.

The display 140 is configured to display an image, and may be implemented as various types of displays, such as liquid crystal displays (LCDs), organic light emitting diodes (OLEDs) displays, plasma display panels (PDPs), and the like. The display 140 may also include a driving circuit, a backlight unit, and the like, which may be implemented in the form of a-si TFTs, low temperature poly silicon (LTPS) TFTs, organic TFTs (OTFTs), and the like. Meanwhile, the display 140 may be implemented as a touch screen combined with a touch sensor, a flexible display, a three-dimensional (3D) display, and the like.

The user interface 150 may be implemented as a button, a touch pad, a mouse, a keyboard, etc., or may be implemented as a touch screen that can also perform a display function and a manipulation input function. Here, the button may be various types of buttons such as a mechanical button, a touch pad, a wheel, etc. formed in any arbitrary area of the main body of the electronic device 100, such as front, side, back, etc.

The microphone 160 is configured to receive sound input and convert it into an audio signal. The microphone 160 is electrically coupled to the processor 120, and may receive sound under the control of the processor 120.

For example, the microphone 160 may be integrally formed with the electronic device 100 as being integrated in the top, front, or side direction of the electronic device 100. Alternatively, the microphone 160 may be provided on a remote controller or the like that is separate from the electronic device 100. In this case, the remote controller may receive sound via the microphone 160 and provide the received sound to the electronic device 100.

The microphone 160 may include various components such as a microphone that collects analog sound, an amplification circuit that amplifies the collected sound, an A/D conversion circuit that samples the amplified sound and converts it into a digital signal, a filter circuit that removes noise components from the converted digital signal, etc.

Meanwhile, the microphone 160 may be implemented in the form of a sound sensor, and any configuration may be used as long as it is configured to collect sound.

The speaker 170 is configured to output not only various audio data processed by the processer 120 but also various notification sounds, voice messages, etc.

The camera 180 is configured to capture still images or moving images. The camera 180 may capture still images at a specific point in time, but may also capture still images continuously.

The camera 180 includes a lens, a shutter, an aperture, a solid-state imaging device, an analog front end (AFE), and a timing generator (TG). The shutter controls the time when light reflected from a subject enters the camera 180, and the aperture controls the amount of light entering the lens by mechanically increasing or decreasing the size of the opening through which the light enters. When the light reflected from the subject is accumulated as a photoelectric charge, the solid-state imaging device outputs an image by the photoelectric charge as an electrical signal. The TG outputs a timing signal to read out the pixel data of the solid-state imaging device, and the AFE samples and digitizes the electrical signal output from the solid-state imaging device.

As described above, the electronic device 100 may remove DC components from the plurality of unshuffled channel groups and input the plurality of channel groups with DC components removed into a neural network model to improve high-resolution performance. Furthermore, since such a subtraction operation is also simple to implement in hardware, change in the structure of existing hardware can be minimized.

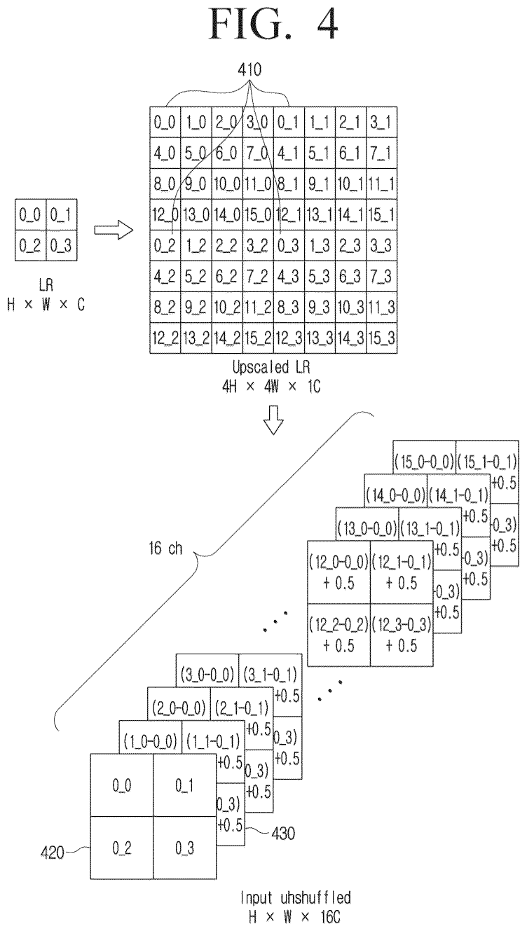

Hereinafter, the operation of the electronic device 100 will be described in greater detail with reference to FIGS. 4 to 8. For convenience of explanation, individual embodiments will be described in FIGS. 4 to 8. However, the individual embodiments of FIGS. 4 to 8 may be implemented in any combination.

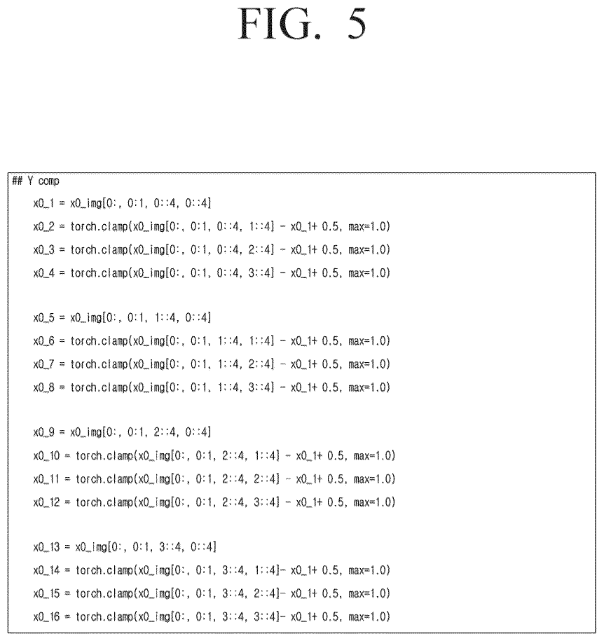

FIGS. 4 and 5 are views provided to explain a preprocessing method according to one or more embodiments.

The processor 120 may obtain an upscaled image by upscaling each of a plurality of pixels included in an image. For example, the processor 120 may upscale an image of H×W×C to 4H×4W×1C, as shown at the top of FIG. 4. Here, the processor 120 may upscale each of the plurality of pixels included in the image to obtain an upscaled image that includes a plurality of sub-images. For example, as shown at the top of FIG. 4, in the process of upscaling the image of H×W×C to 4H×4W×1C, the processor 120 may upscale each of pixels 0_0, 0_1, 0_2, and 0_3 included in the image of H×W×C and accordingly, the upscaled image may include pixels 0_0, 0_1, 0_2, and 0_3 as shown in 410. In other words, the processor 120 may upscale pixel 0_0 to 0_0˜15_0, upscale pixel 0_1 to 0_1˜15_1, upscale pixel 0_2 to 0_2˜15_2, and upscale pixel 0_3 to 0_3˜15_3.

The processor 120 may unshuffle a plurality of pixels included in the upscaled image to obtain a plurality of channel groups. For example, the processor 120 may obtain a first group 420 that includes pixels 0_0, 0_1, 0_2, and 0_3 in the upscaled image, as shown at the bottom of FIG. 4. The processor 120 may then obtain second to sixteenth groups by subtracting corresponding pixel values in the first group 420 from the remaining pixel values in the upscaled image. For example, the processor 120 may obtain a second group 430 including pixels 1_0, 1_1, 1_2, and 1_3 disposed to the right of each of pixels 0_0, 0_1, 0_2, and 0_3 in the upscaled image, and subtract pixel values 0_0, 0_1, 0_2, and 0_3 corresponding to pixel values 1_0, 1_1, 1_2, and 1_3, respectively. The processor 120 may obtain third group to sixteenth groups in a similar manner, and each operation may be expressed as follows.

Ch1: 0_0, 0_1, 0_2, 0_3

Ch2: (1_0-0_0), (1_1-0_1), (1_2-0_2), (1_3-0_3)

Ch3: (2_0-0_0), (2_1-0_1), (2_2-0_2), (2_3-0_3)

Ch4: (3_0-0_0), (3_1-0_1), (3_2-0_2), (3_3-0_3)

Ch5: (4_0-0_0), (4_1-0_1), (4_2-0_2), (4_3-0_3)

. . .

Ch16: (15_0-0_0), (15_1-0_1), (15_2-0_2), (15_3-0_3)

The processor 120 may update each group except for the first group by subtracting a middle value from the pixel value of each group except for the first group. For example, the processor 120 may update each group except for the first group by subtracting a middle value of 0.5 from the pixel value of each group except for the first group. Here, the middle value of 0.5 is a middle value between the minimum pixel value and the maximum pixel value, which is because the pixel values of the image are normalized to 0˜1. The operation of normalizing the pixel values of the image may be performed prior to upscaling. However, the present disclosure is not limited thereto, and normalizing may not be performed. In this case, for example, if the minimum pixel value is 0 and the maximum pixel value is 255, the middle value may be 128.

When the subtracted value exceeds the preset first value, the processor 120 may update the plurality of channel groups by clamping the subtracted value to the preset first value. Here, the preset first value may be the maximum pixel value. In FIG. 4, the pixel values of the image are normalized from 0˜1, so the processor 120 may clamp the subtracted value to 1 when the subtracted value exceeds 1.

Through such a subtraction operation, data with DC components removed is input to the neural network model, which means that the amount of change is input. Accordingly, the upscaling performance of the neural network model that performs high-resolution in which changes in high-frequency texture areas or edges with large differences from neighboring pixels can be more meaningful, may be further improved.

Such an operation may be implemented through code as shown in FIG. 5. In FIG. 5, torch.clamp may be an instruction representing a clamping behavior.

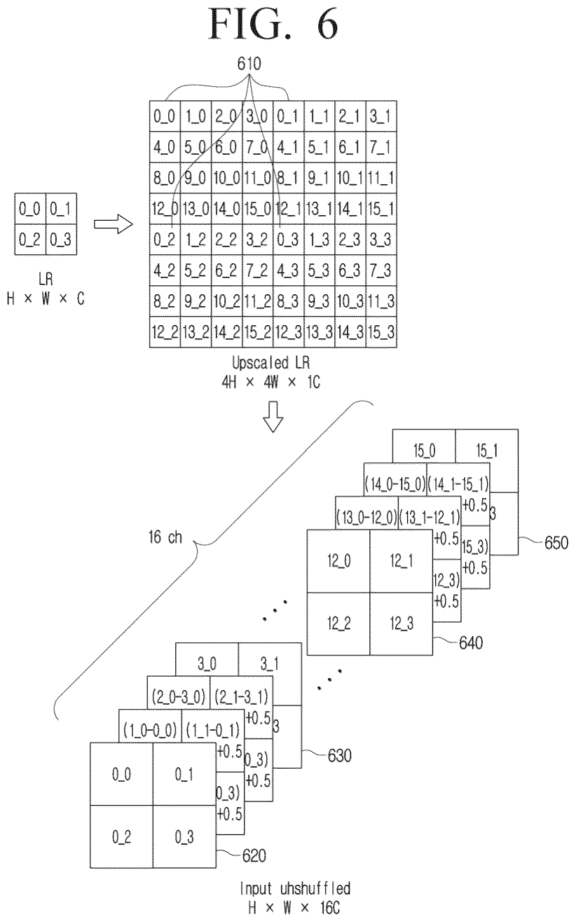

FIGS. 6 to 8 are views provided to explain a preprocessing method according to one or more embodiments.

The processor 120 may upscale each of the plurality of pixels included in the image to obtain an upscaled image including a plurality of sub-images. For example, the processor 120 may upscale pixel 0_0 from 0_0˜15_0 to obtain a first sub-image, upscale pixel 0_1 from 0_1˜15_1 to obtain a second sub-image, upscale pixel 0_2 from 0_2˜15_2 to obtain a third sub-image, and upscale pixel 0_3 from 0_3˜15_3 to obtain a fourth sub-image, as shown at the top of FIG. 6. Here, each sub-image may include one of the plurality of pixels included in the image, and the upscaled image may include pixels 0_0, 0_1, 0_2, and 0_3, as shown in 610.

The processor 120 may identify a pixel disposed at a vertex in each of the plurality of sub-images as the plurality of preset pixels. For example, the processor 120 may identify 0_0, 3_0, 12_0, 15_0 in the first sub-image as the preset pixels, 0_1, 3_1, 12_1, 15_1 in the second sub-image as the preset pixels, 0_2, 3_2, 12_2, 15_2 in the third sub-image as the preset pixels, and 0_3, 3_3, 12_3, 15_3 in the fourth sub-image as the preset pixels.

The processor 120 may obtain some channel groups with the remaining pixels excluding preset pixels from the upscaled image, and obtain the remaining channel groups as the preset pixels. For example, the processor 120 may obtain the second, third, fifth to twelfth, fourteenth, and fifteenth groups with the remaining pixels excluding the preset pixels from the upscaled image, obtain a first group 620 including pixels 0_0, 0_1, 0_2, 0_3, obtain a fourth group 630 including pixels 3_0, 3_1, 3_2, 3_3, obtain a thirteenth group 640 including pixels 12_0, 12_1, 12_2, 12_3, and obtain a sixteenth group 650 including pixels 15_0, 15_1, 15_2, 15_3. Hereinafter, for convenience of explanation, the second, third, fifth to twelfth, fourteenth, and fifteenth groups are described as some of the channel groups, and the first group 620, fourth group 630, thirteenth group 640, and sixteenth group 650 are described as the remaining channel groups.

The processor 120 may update the plurality of channel groups by subtracting a preset pixel value that is closest to a position of a pixel included in each of some channel groups among the plurality of preset pixels included in the plurality of sub-images from a pixel value included in each of some channel groups among the plurality of channel groups.

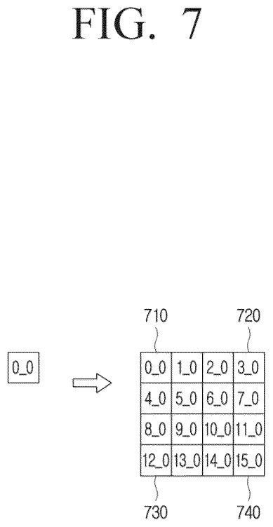

First, the pixel value closest to each pixel will be described with reference to FIG. 7.

The processor 120 may upscale 0_0 of the image to obtain a sub-image, as shown on the right side of FIG. 7. Here, pixel 0_0 (710), pixel 3_0 (720), pixel 12_0 (730), and pixel 15_0 (740) are pixels forming the remaining channel groups, and the remaining pixels are pixels forming some channel groups. The processor 120 may subtract a preset pixel value that is close to the remaining pixels from the remaining pixel values. For example, the processor 120 may subtract pixel 0_0 (710) from pixels 1_0, 4_0, 5_0, pixel 3_0 (720) from pixels 2_0, 6_0, 7_0, pixel 12_0 (730) from pixels 8_0, 9_0, 13_0, and pixel 15_0 (740) from pixels 10_0, 11_0, 14_0.

The processor 120 may subtract the pixels excluding the preset pixels among the pixels included in all sub-images in the manner described above, and each operation may be represented as follows.

Ch1: 0_0, 0_1, 0_2, 0_3

Ch2: (1_0-0_0), (1_1-0_1), (1_2-0_2), (1_3-0_3)

Ch5: (4_0-0_0), (4_1-0_1), (4_2-0_2), (4_3-0_3)

Ch6: (5_0-0_0), (5_1-0_1), (5_2-0_2), (5_3-0_3)

. . .

Ch16: 15_0, 15_1, 15_2, 15_3

Ch11: (10_0-15_0), (10_1-15_1), (10_2-15_2), (10_3-15_3)

Ch12: (11_0-15_0), (11_1-15_1), (11_2-15_2), (11_3-15_3)

Ch15: (14_0-15_0), (14_1-15_1), (14_2-15_2), (14_3-15_3)

The processor 120 may update some groups by subtracting a middle value from the pixel value of some groups excluding the first group 620, the fourth group 630, the thirteenth group 640, and the sixteenth group 650. For example, the processor 120 may update some groups by subtracting a middle value of 0.5 from the pixel value of some groups excluding the first group 620, the fourth group 630, the thirteenth group 640, and the sixteenth group 650. Here, the middle value of 0.5 is a middle value between the minimum pixel value and the maximum pixel value because the pixel values of the image have been normalized to 0˜1. The operation of normalizing the pixel values of the image may be performed prior to upscaling. However, the present disclosure is not limited thereto, and normalization may not be performed. In this case, for example, if the minimum pixel value is 0 and the maximum pixel value is 255, the middle value might be 128.

The processor 120 may update the plurality of channel groups by clamping the subtracted value to the preset first value when the subtracted value exceeds the preset first value. Here, the preset first value may be the maximum pixel value. In FIG. 4, the pixel values of the image are normalized from 0˜1, so the processor 120 may clamp the subtracted value to 1 when the subtracted value exceeds 1.

The data with the DC components removed through the above subtraction operation may be input into the neural network model. In particular, compared to the operation in FIG. 4, the upscaling performance of the neural network model may be further improved as the difference with a more adjacent periphery is used as input.

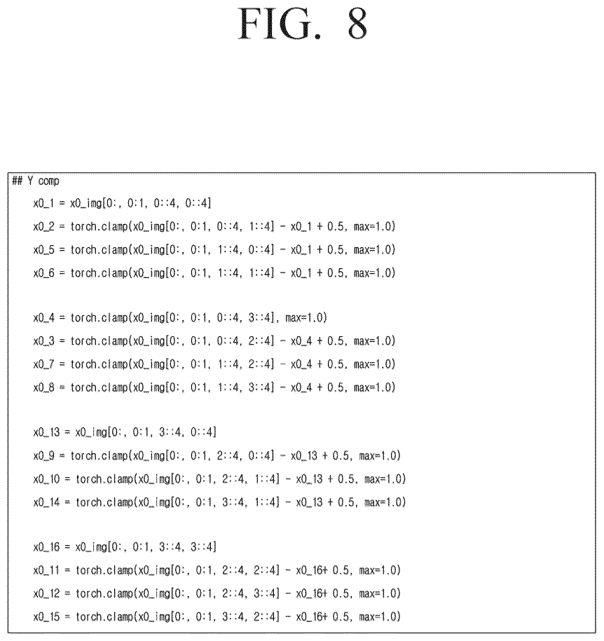

Such an operation may be implemented through code as shown in FIG. 8.

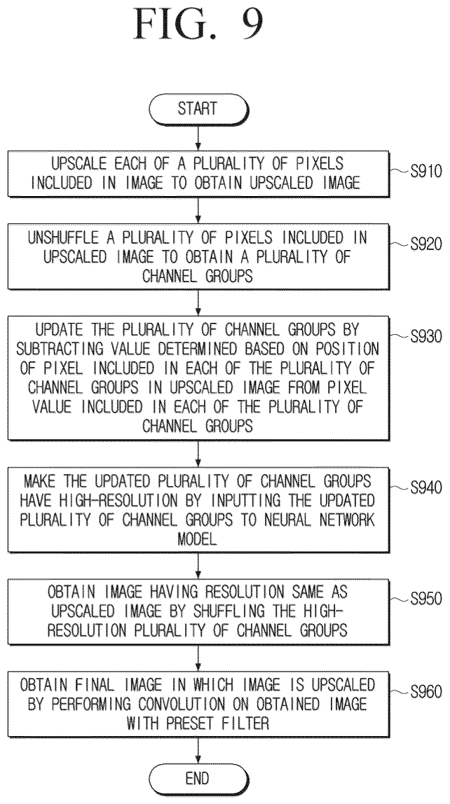

FIG. 9 is a flowchart provided to explain a controlling method of an electronic device according to one or more embodiments.

First, each of a plurality of pixels in the image is upscaled to obtain an upscaled image (S910). Subsequently, the plurality of pixels in the upscaled image are unshuffled to obtain a plurality of channel groups (S920). Then, the plurality of channel groups are updated by subtracting a value determined based on the position of a pixel included in each of the plurality of channel groups in the upscaled image from a pixel value included in each of the plurality of channel groups with (S930). The updated plurality of channel groups are then input to a neural network model to make the updated plurality of channel groups have high-resolution (S940). Subsequently, the high-resolution plurality of channel groups are then shuffled to obtain an image having the same resolution as the upscaled image (S950). Convolution is performed on the obtained image with a preset filter to obtain a final image in which the image is upscaled (S960).

Further, the step of obtaining the plurality of channel groups (S920) may include obtaining a first group among the plurality of channel groups as a group corresponding to the image, and the step of updating (S930) may include updating the plurality of channel groups by subtracting the pixel values of the first group corresponding to the pixels included in each of the plurality of second groups from the pixel value included in each of a plurality of second groups, which are the remainder of the plurality of channel groups.

The step of obtaining the upscaled image (S910) may include upscaling each of the plurality of pixels included in the image to obtain an upscaled image comprising a plurality of sub-images, and the step of updating (S930) may include updating the plurality of channel groups by subtracting a preset pixel value closest to a position of a pixel included in each of the plurality of channel groups among a plurality of preset pixels included in a plurality of sub-images from a pixel value included in each of the plurality of channel groups.

Further, the step of obtaining the plurality of channel groups (S920) may include obtaining the remaining channel groups excluding some of the channel groups among the plurality of channel groups based on the plurality of preset pixels.

The step of obtaining the plurality of channel groups (S920) may include identifying a pixel disposed at a vertex in each of the plurality of sub-images as the plurality of preset pixels.

Further, the step of updating (S930) may include updating the plurality of channel groups by subtracting an average value of the plurality of pixels included in the upscaled image from a pixel value included in each of the plurality of channel groups.

Subsequently, the step of obtaining the plurality of channel groups (S920) may include obtaining a first group of the plurality of channel groups as a group corresponding to the image, and the step of updating (S930) may include updating the plurality of channel groups by subtracting one of an average value and a median value of a plurality of pixels included in the first group from a pixel value included in each of the plurality of second groups, which are the remainder of the plurality of channel groups.

Further, the step of updating (S930) may include, when the subtracted values exceed a preset first value, updating the plurality of channel groups by clamping the subtracted values to the preset first value, and the preset first value may be the maximum pixel value.

In addition, the step of updating (S930) may include subtracting a determined value and a preset second value from a pixel values included in each of the plurality of channel groups to obtain the subtracted value, and the preset second value may be a middle value between the minimum pixel value and the maximum pixel value.

Further, the step of making channels have high-resolution (S940) may include inputting the updated plurality of channel groups into a neural network model to make the updated plurality of channel groups have 1:1 high-resolution, and the step of obtaining an image having the same resolution as the upscaled image (S950) may include shuffling the plurality of 1:1 high-resolution channel groups to obtain an image having the same resolution as the upscaled image.

In accordance with the various embodiments of the present disclosure, an electronic device may remove DC components from a plurality of unshuffled channel groups and input the plurality of channel groups with the DC components removed into a neural network model to improve high-resolution performance.

Further, since such a subtraction operation is simple to implement in hardware, changes to the existing hardware structure can be minimized.

Meanwhile, according to one or more embodiments, the above-described various embodiments may be implemented as software including instructions stored in machine-readable storage media, which can be read by machine (e.g.: computer). The machine refers to a device that calls instructions stored in a storage medium, and can operate according to the called instructions, and the device may include an electronic device (e.g., electronic device A) according to the aforementioned embodiments. In case an instruction is executed by a processor, the processor may perform a function corresponding to the instruction by itself, or by using other components under its control. The instruction may include a code that is generated or executed by a compiler or an interpreter. The machine-readable storage medium may be provided in the form of a non-transitory storage medium. Here, the term ‘non-transitory’ means that the storage medium is tangible without including a signal, and does not distinguish whether data are semi-permanently or temporarily stored in the storage medium.

In addition, according to one or more embodiments, the above-described methods according to the various embodiments may be included and provided in a computer program product. The computer program product may be traded as a product between a seller and a purchaser. The computer program product may be distributed in a form of a storage medium (e.g., a compact disc read only memory (CD-ROM)) that may be read by the machine or online through an application store (e.g., PlayStore™). In case of the online distribution, at least a portion of the computer program product may be at least temporarily stored in a storage medium such as memory of a server of a manufacturer, a server of an application store, or a relay server or be temporarily generated.

Further, according to one or more embodiments, the above-described various embodiments may be implemented in a recording medium that can be read by a computer or a similar device using software, hardware, or a combination thereof. In some cases, embodiments described herein may be implemented by a processor itself. According to software implementation, embodiments such as procedures and functions described in this specification may be implemented as separate software. Each software may perform one or more functions and operations described in this disclosure.

Meanwhile, computer instructions for performing processing operations of the device according to the above-described various embodiments may be stored in a non-transitory computer-readable medium. When being executed by a processor of a specific device, the computer instructions stored in such a non-transitory computer-readable medium allows the specific device to perform processing operations in the electronic device according to the above-described various embodiments. The non-transitory computer-readable medium refers to a medium that stores data semi-permanently and can be read by a device, rather than a medium that stores data for a short period of time, such as registers, caches, memory, etc. Specific examples of the non-transitory computer-readable medium may include CD, DVD, hard disk, Blu-ray disk, USB, memory card, ROM, etc.

Further, the components (e.g., modules or programs) according to various embodiments described above may include a single entity or a plurality of entities, and some of the corresponding sub-components described above may be omitted or other sub-components may be further included in the various embodiments. Alternatively or additionally, some components (e.g., modules or programs) may be integrated into one entity and perform the same or similar functions performed by each corresponding component prior to integration. Operations performed by the modules, the programs, or the other components according to the various embodiments may be executed in a sequential manner, a parallel manner, an iterative manner, or a heuristic manner, or at least some of the operations may be performed in a different order or be omitted, or other operations may be added.

Although preferred embodiments of the present disclosure have been shown and described above, the disclosure is not limited to the specific embodiments described above, and various modifications may be made by one of ordinary skill in the art without departing from the gist of the disclosure as claimed in the claims, and such modifications are not to be understood in isolation from the technical ideas or prospect of the disclosure.

What is claimed is:

1. An electronic device comprising:
memory storing one or more instructions; and
at least one processor configured to individually or collectively execute the one or more instructions,
wherein the one or more instructions, when individually or collectively executed by the at least one processor, cause the electronic device to:
obtain an upscaled image by upscaling each of a plurality of pixels of an image;
obtain a plurality of channel groups by unshuffling a plurality of pixels of the upscaled image;
update the plurality of channel groups by subtracting a value based on a position of a pixel included in each of the plurality of channel groups in the upscaled image from a pixel value included in each of the plurality of channel groups;
generate a high-resolution plurality of channel groups by inputting the updated plurality of channel groups to a neural network model stored in the memory;
obtain a processed image having a resolution that is the same as a resolution of the upscaled image by shuffling the high-resolution plurality of channel groups; and
obtain a final image in which the image is upscaled by performing convolution on the processed image with a preset filter.

2. The electronic device of claim 1, wherein the one or more instructions, when individually or collectively executed by the at least one processor, further cause the electronic device to:
obtain a first channel group among the plurality of channel groups as a channel group corresponding to the image; and
update the plurality of channel groups by subtracting a pixel value of the first channel group corresponding to a pixel included in each of a plurality of second channel groups from a pixel value included in each of the plurality of second channel groups, wherein the plurality of second channel groups is included in the plurality of channel groups.

3. The electronic device of claim 1,
wherein the upscaled image comprises a plurality of sub images, and
wherein the one or more instructions, when individually or collectively executed by the at least one processor, further cause the electronic device to:
obtain the upscaled image by upscaling each of a plurality of pixels included in the image; and
update the plurality of channel groups by subtracting a preset pixel value closest to a position of a pixel included in each of a first subset of channel groups among the plurality of channel groups, among a plurality of preset pixels included in the plurality of sub images, from a pixel value included in each of the first subset of channel groups.

4. The electronic device of claim 3, wherein the one or more instructions, when individually or collectively executed by the at least one processor, further cause the electronic device to obtain, based on the plurality of pixels, a second subset of channel groups comprising remaining channel groups, among the plurality of channel groups, excluding the first subset of channel groups.

5. The electronic device of claim 3, wherein the one or more instructions, when individually or collectively executed by the at least one processor, further cause the electronic device to collectively identify a pixel at a vertex in each of the plurality of sub images as the plurality of preset pixels.

6. The electronic device of claim 1, wherein the one or more instructions, when individually or collectively executed by the at least one processor, further cause the electronic device to update the plurality of channel groups by subtracting an average value of a plurality of pixels included in the upscaled image from a pixel value included in each of the plurality of channel groups.

7. The electronic device of claim 1, wherein the one or more instructions, when individually or collectively executed by the at least one processor, further cause the electronic device to:
obtain a first channel group among the plurality of channel groups as a channel group corresponding to the image; and
update the plurality of channel groups by subtracting one of an average value and a median value of a plurality of pixels included in the first channel group from a pixel value included in each of a plurality of second groups, wherein the plurality of second groups comprises all channel groups of the plurality of channel groups excluding the first channel group.

8. The electronic device of claim 1, wherein the one or more instructions, when individually or collectively executed by the at least one processor, further cause the electronic device to, based on the subtracted value exceeding a preset first value, update the plurality of channel groups by clamping the subtracted value to the preset first value,
wherein the preset first value is a maximum pixel value.

9. The electronic device of claim 8, wherein the one or more instructions, when individually or collectively executed by the at least one processor, further cause the electronic device to obtain the subtracted value by subtracting the preset first value and a preset second value from a pixel value included in each of the plurality of channel groups,
wherein the preset second value is a middle value between a minimum pixel value and the maximum pixel value.

10. The electronic device as claimed in claim 1, wherein the one or more instructions, when individually or collectively executed by the at least one processor, further cause the electronic device to:
cause the high-resolution plurality of channel groups to have 1:1 high-resolution by inputting the updated plurality of channel groups to the neural network model; and
obtain the processed image having the same resolution as the upscaled image by shuffling the plurality of 1:1 high-resolution channel groups.

11. A method of controlling an electronic device, the method comprising:
obtaining an upscaled image by upscaling each of a plurality of pixels of an image;
obtaining a plurality of channel groups by unshuffling a plurality of pixels of the upscaled image;
updating the plurality of channel groups by subtracting a value based on a position of a pixel included in each of the plurality of channel groups in the upscaled image from a pixel value included in each of the plurality of channel groups;
generating a high-resolution plurality of channel groups by inputting the updated plurality of channel groups to a neural network model stored in a memory of the electronic device;
obtaining a processed image having a resolution that is the same as a resolution of the upscaled image by shuffling the high-resolution plurality of channel groups; and
obtaining a final image in which the image is upscaled by performing convolution on the processed image with a preset filter.

12. The method of claim 11,
wherein the obtaining the plurality of channel groups further comprises obtaining a first channel group among the plurality of channel groups as a channel group corresponding to the image, and
wherein the updating the plurality of channel groups further comprises subtracting a pixel value of the first channel group corresponding to a pixel included in each of a plurality of second channel groups from a pixel value included in each of the plurality of second channel groups, wherein the plurality of second channel groups is included in the plurality of channel groups.

13. The method of claim 11,
wherein the upscaled image comprises a plurality of sub images,
wherein the obtaining the upscaled image further comprises upscaling each of a plurality of pixels included in the image to obtain the upscaled image; and
wherein the updating the plurality of channel groups further comprises subtracting a preset pixel value closest to a position of a pixel included in each of a first subset of channel groups among the plurality of channel groups, among a plurality of preset pixels included in the plurality of sub images, from a pixel value included in each of the first subset of channel groups.

14. The method of claim 13, wherein the obtaining the plurality of channel groups further comprises obtaining, based on the plurality of preset pixels, a second subset of channel groups comprising remaining channel groups, among the plurality of channel groups, excluding the first subset of channel groups.

15. The method of claim 13, wherein the obtaining the plurality of channel groups further comprises collectively identifying a pixel at a vertex in each of the plurality of sub images as the plurality of preset pixels.
